(19) United States
(12) Patent Application Publication
(10) Pub. No.: US 2016/0039467 A1
(43) Pub. Date: Feb. 11, 2016

(54) VEHICLE LOWER SECTION STRUCTURE

(71) Applicant: TOYOTA JIDOSHA KABUSHIKI KAISHA, Toyota-shi (JP)

(72) Inventor: Susumu TAKENAKA, Toyota-shi (JP)

(73) Assignee: TOYOTA JIDOSHA KABUSHIKI KAISHA, Toyota-shi (JP)

(21) Appl. No.: 14/795,065

(22) Filed: Jul. 9, 2015

(30) Foreign Application Priority Data
Aug. 5, 2014 (JP) 2014-159668

(51) Int. Cl. B62D 21/15; B62D 25/20; B62D 21/06; B62D 21/08

(52) U.S. Cl. CPC B62D 21/155; B62D 21/08; B62D 25/20; B62D 21/06

(57) ABSTRACT

The present disclosure relates to a vehicle lower section structure that may obtain efficient load transmission obliquely toward the rear side, even in the event of an oblique collision. A reinforcement member is coupled to one lower tunnel reinforcement, and is coupled to another a lower tunnel reinforcement on progression toward the rear side. Collision load transmitted to the reinforcement member is accordingly transmitted obliquely toward the rear from the one lower tunnel reinforcement to the other lower tunnel reinforcement. Namely, the vehicle lower section structure of the present disclosure is capable of obtaining effective load transmission obliquely toward the rear side even in the event of an oblique collision.

### CROSS-REFERENCE TO RELATED APPLICATION

This application claims priority under 35 USC 119 from Japanese Patent Application No. 2014-159668, filed on Aug. 5, 2014, the disclosure of which is incorporated by reference herein.

### BACKGROUND OF THE INVENTION

1. Field of the Invention

The present disclosure relates to a vehicle lower section structure.

2. Description of the Related Art

Technology is described in Japanese Patent Application Laid-Open (JP-A) No. H06-144300 that includes a floor panel (tunnel section) extending along the vehicle front-rear direction at a central portion in the vehicle width direction of a front floor (floor), and a rectangular shaped reinforcement plate formed with plural triangular shaped holes in an up-down direction central portion of a front end section side of the floor panel.

For example, in an oblique collision from the vehicle width direction outer side of a side member, a large collision load is input from the side member along an oblique direction of the vehicle. In such cases, there is a possibility in the above structure that the collision load is not transmitted effectively from the side member to the floor panel, due the side member and the floor panel not being directly connected to each other.

Technology is described in JP-A No. 2013-103560 in which an extension section (side member) extends from a rear end portion of a front side frame, and a first core (coupling portion) is provided to couple a rear portion of the extension section to a tunnel frame (tunnel section). In such cases collision load from the extension section is transmitted to the tunnel frame through the first core.

For example, if the technology described in JP-A No. 2013-103650 were to be applied to the technology described in JP-A No. H06-144300, then in the event of an oblique collision, collision load transmitted from the extension section to the tunnel frame through the first core would be transmitted to the reinforcement plate through the tunnel frame.

However, due to the reinforcement plate being configured by a rectangular shape formed with plural triangular holes, the possibility arises that effective load transmission with the floor tunnel will not be achieved in cases in which a large collision load has been transmitted to the floor panel.

### SUMMARY OF THE INVENTION

The present disclosure obtains a vehicle lower section structure capable of obtaining effective load transmission in an oblique direction toward the rear side, even in an oblique collision.

A first aspect is a vehicle lower section structure including: a tunnel section that projects out toward an upper side in a vehicle up-down direction and extends along a vehicle front-rear direction at a central portion in a vehicle width direction of a floor of a vehicle cabin; a pair of tunnel reinforcements that are each joined to a lower face side of the floor, that are each disposed at a vehicle width direction outer side of the tunnel section, and that each extend in the vehicle front-rear direction; a side member that is disposed at an outer side of the respective tunnel reinforcement in the vehicle width direction and is provided along the vehicle front-rear direction; a coupling portion that extends from a vehicle front-rear direction front end portion of the respective tunnel reinforcement, or is provided at a vehicle front-rear direction front end portion of the respective tunnel reinforcement, and that couples the tunnel reinforcement and the side member together; and a reinforcement member of which a front portion side in the vehicle front-rear direction is joined to the coupling portion on the side of one of the tunnel reinforcements, and of which a rear portion side in the vehicle front-rear direction is joined to the other tunnel reinforcement.

In the vehicle lower section structure of the first aspect, the tunnel section is provided at the central portion in the vehicle width direction of the floor of the vehicle cabin, and the tunnel section projects out toward the upper side in the vehicle up-down direction, and extends along the vehicle front-rear direction. At the lower face side of the floor, the pair of tunnel reinforcements are each joined to the vehicle width direction outer side of the tunnel section, and the tunnel reinforcements each extend in the vehicle front-rear direction. Each of the side members is disposed at the outer side of the respective tunnel reinforcement in the vehicle width direction and the side members are provided along the vehicle front-rear direction.

The coupling portion extends from the vehicle front-rear direction front end portion of the respective tunnel reinforcement, or is provided to the vehicle front-rear direction front end portion of the respective tunnel reinforcement. The tunnel reinforcement and the side member together are coupled together by the coupling portion.

The front portion side in the vehicle front-rear direction of the reinforcement member is joined to the coupling portion on the one tunnel reinforcement side, and the rear portion side in the vehicle front-rear direction of the reinforcement member is joined to the other tunnel reinforcement. Namely, the reinforcement member is disposed obliquely to the tunnel section extension direction (the vehicle front-rear direction).

In the event of what is referred to as an oblique collision, for example, a large collision load is input from the side member that is on the one tunnel reinforcement side along an oblique direction to the vehicle. In the first aspect, when the collision load is input to the side member, collision load is transmitted from the side member to the coupling portion. Due to the front portion side in the vehicle front-rear direction of the reinforcement member being joined to the coupling portion, the collision load transmitted to the reinforcement member is transmitted obliquely toward the rear side, and is transmitted from the one tunnel reinforcement to the other tunnel reinforcement. Namely, the collision load is transmitted past the tunnel section, to the tunnel reinforcement on the opposite side to the collision side.

A second aspect is a vehicle lower section structure including: a tunnel section that projects out toward an upper side in a vehicle up-down direction and extends along a vehicle front-rear direction at a central portion in a vehicle width direction of a floor of a vehicle cabin; a pair of tunnel reinforcements that are each joined to an upper face side of the floor, that are each disposed at a vehicle width direction outer side of the tunnel section, and that each extend in the vehicle front-rear direction; a side member that is disposed at an outer side of the respective tunnel reinforcement in the vehicle width direction and is provided along the vehicle front-rear direction; a coupling portion that extends from a vehicle front-rear direction front end portion of the respective tunnel reinforcement, or is provided at a vehicle front-rear direction front end portion of the respective tunnel reinforcement, and that couples the tunnel reinforcement and the side member together; and a reinforcement member of which a front portion side in the vehicle front-rear direction is joined to the floor at a position overlapping in plan view with the coupling portion that is on the side of one of the tunnel reinforcements at a lower face side of the floor, and of which a rear portion side in the vehicle front-rear direction is joined to the floor at a position overlapping in plan view with the other tunnel reinforcement.

In the vehicle lower section structure of the second aspect, the tunnel section is provided at the central portion in the vehicle width direction of the floor of the vehicle cabin, and the tunnel section projects out toward the upper side in the vehicle up-down direction, and extends along the vehicle front-rear direction. At the upper face side of the floor, the pair of tunnel reinforcements are each joined to the vehicle width direction outer side of the tunnel section, and the tunnel reinforcements each extend in the vehicle front-rear direction. Each of the side members is disposed at the outer side of the respective tunnel reinforcement in the vehicle width direction and the side members are provided along the vehicle front-rear direction.

The coupling portion extends from the vehicle front-rear direction front end portion of the respective tunnel reinforcement, or is provided to the vehicle front-rear direction front end portion of the respective tunnel reinforcement, and the tunnel reinforcement and the side member are coupled together by the coupling portion.

At the lower face side of the floor, the front portion side in the vehicle front-rear direction of the reinforcement member is joined to the floor at a position overlapping in plan view with the coupling portion that is on the one tunnel reinforcement side, and the rear portion side in the vehicle front-rear direction of the reinforcement member is joined to the floor at a position overlapping in plan view with the other tunnel reinforcement. Namely, the reinforcement member is disposed obliquely to the tunnel section extension direction (the vehicle front-rear direction).

In the second aspect, when a collision load is input to the side member, collision load is transmitted from the side member to the coupling portion. Due to the front portion side in the vehicle front-rear direction of the reinforcement member being joined to the coupling portion, the collision load transmitted to the reinforcement member is transmitted obliquely toward the rear side through the floor, and is transmitted from the one tunnel reinforcement to the other tunnel reinforcement. Namely, the collision load is transmitted past the tunnel section through the floor, to the tunnel reinforcement on the opposite side to the collision side.

A third aspect, in the above aspects, reinforcement members may be respectively provided to each of the pair of tunnel reinforcements so as to intersect each other.

In the vehicle lower section structure of the third aspect, due to the reinforcement members being respectively provided to each of the pair of tunnel reinforcements so as to intersect each other, deformation of the tunnel section with respect to shear force acting on the tunnel section along the vehicle width direction can be suppressed.

A fourth aspect, in the above aspects, may further include: a pair of rockers respectively disposed at each vehicle width direction side of the floor and extending along the vehicle front-rear direction; and a floor cross member that couples the respective rocker to the tunnel section in the vehicle width direction, wherein a first joint portion where the rear portion side of the reinforcement member in the vehicle front-rear direction is joined to the tunnel reinforcement, and a second joint portion where the floor cross member is joined to the tunnel section, may overlap with each other in plan view.

In the vehicle lower section structure of the fourth aspect, the pair of rockers are respectively disposed at each vehicle width direction side of the floor and the rockers extend along the vehicle front-rear direction. The rockers and tunnel section are coupled together in the vehicle width direction by the floor cross member. In this configuration, for example, the first joint portion where the rear portion side in the vehicle front-rear direction of the reinforcement member is joined to the other tunnel reinforcement, and the second joint portion where the floor cross member is joined to the tunnel section, overlap with each other in plan view.

Thus, for example, part of collision load transmitted through the reinforcement member from one tunnel reinforcement to the other tunnel reinforcement is distributed to the floor cross member through the first joint portion of the reinforcement member and the second joint portion of the floor cross member. This thereby enables transmission through the floor cross member to the rocker side.

Reference here to “overlap” does not indicate the strict literal meaning of “overlap”, and indicates “substantial overlap”, and means that some misalignment in plan view is permissible as long as it is within a range enabling collision load to be transmitted from the reinforcement member to the floor cross member.

A fifth aspect, in the above aspects, the reinforcement member may be configured by a member that has a hollow rectangular cross-section profile, and may be provided with a reinforced portion with raised cross-sectional rigidity in a hollow portion.

In the vehicle lower section structure of the fifth aspect, due to the reinforcement member being configured by a member that has a hollow rectangular cross-section profile, and being provided with the reinforced portion with raised cross-sectional rigidity in the hollow portion, the cross-sectional rigidity of the reinforcement member may be raised while achieving a reduction in weight.

As explained above, the vehicle lower section structure of the first aspect may achieve effective load transmission obliquely toward the rear side even in the event of an oblique collision.

The vehicle lower section structure of the second aspect may achieve effective load transmission obliquely toward the rear side even in the event of an oblique collision.

The vehicle lower section structure of the third aspect may suppress deformation of the tunnel section.

The vehicle lower section structure of the fourth aspect may distribute collision load.

The vehicle lower section structure of the fifth aspect may raise the cross-sectional rigidity while achieving a reduction in weight.

### BRIEF DESCRIPTION OF THE DRAWINGS

Exemplary embodiments of the present invention will be described in detail based on the following figures, wherein:

FIG. 1 is a bottom view illustrating a vehicle lower section structure according to an exemplary embodiment;

FIG. 2 is a perspective view illustrating a vehicle lower section structure according to the present exemplary embodiment, as viewed obliquely from the front side and lower side;

FIG. 3A is a bottom view corresponding to FIG. 1 to explain operation of a vehicle lower section structure according to the present exemplary embodiment;

FIG. 3B is a bottom view corresponding to FIG. 8 to explain operation of a vehicle lower section structure according to the present exemplary embodiment;

FIG. 3C is a modified example of FIG. 3B to explain operation of a vehicle lower section structure according to the present exemplary embodiment;

FIG. 4A is a cross-section of a coupling member configuring a portion of a vehicle lower section structure according to a modified example of the present exemplary embodiment shown in FIG. 4B;

FIG. 4B is a cross-section of a coupling member configuring a portion of a vehicle lower section structure according to the present exemplary embodiment;

FIG. 5 is a perspective view illustrating a coupling member configuring a portion of a vehicle lower section structure according to the present exemplary embodiment;

FIG. 6 is a bottom view corresponding to FIG. 1 and illustrating operation of the vehicle lower section structure according to the present exemplary embodiment;

FIG. 7 is a perspective view corresponding to FIG. 2 and illustrating a (second) modified example of a vehicle lower section structure according to the present exemplary embodiment;

FIG. 8 is a bottom view corresponding to FIG. 1 and illustrating a (fourth) modified example of a vehicle lower section structure according to the present exemplary embodiment;

FIG. 9 is a bottom view corresponding to FIG. 8 and illustrating operation of a (fourth) modified example of a vehicle lower section structure according to the present exemplary embodiment;

FIG. 10A is a bottom view illustrating a Comparative Example; and FIG. 10B is a bottom view illustrating a Comparative Example.

### DETAILED DESCRIPTION OF THE INVENTION

Explanation follows regarding a vehicle lower section structure according to an exemplary embodiment, with reference to the drawings. In each of the drawings, arrow FR, arrow UP, arrow RH, and arrow LH indicate, as appropriate, the front direction, up direction, right direction, and left direction of a vehicle applied with a vehicle lower section structure 10 according to the present exemplary embodiment. In the following, simple reference to directions front-rear, up-down, and left-right indicate front-rear in the vehicle front-rear direction, up-down in the vehicle up-down direction, and left-right direction when facing forwards, unless stated otherwise.

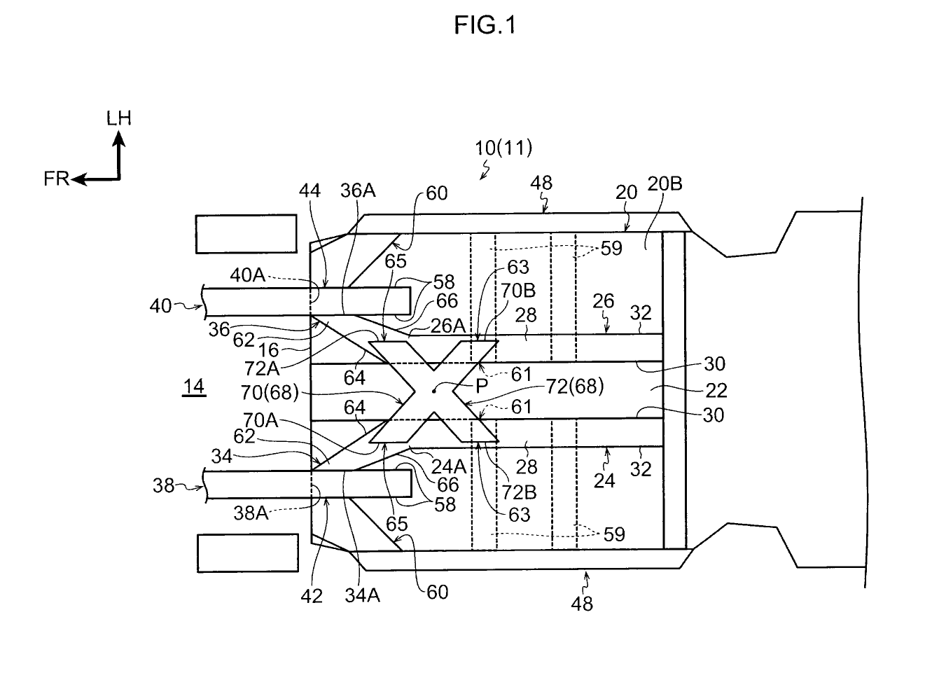

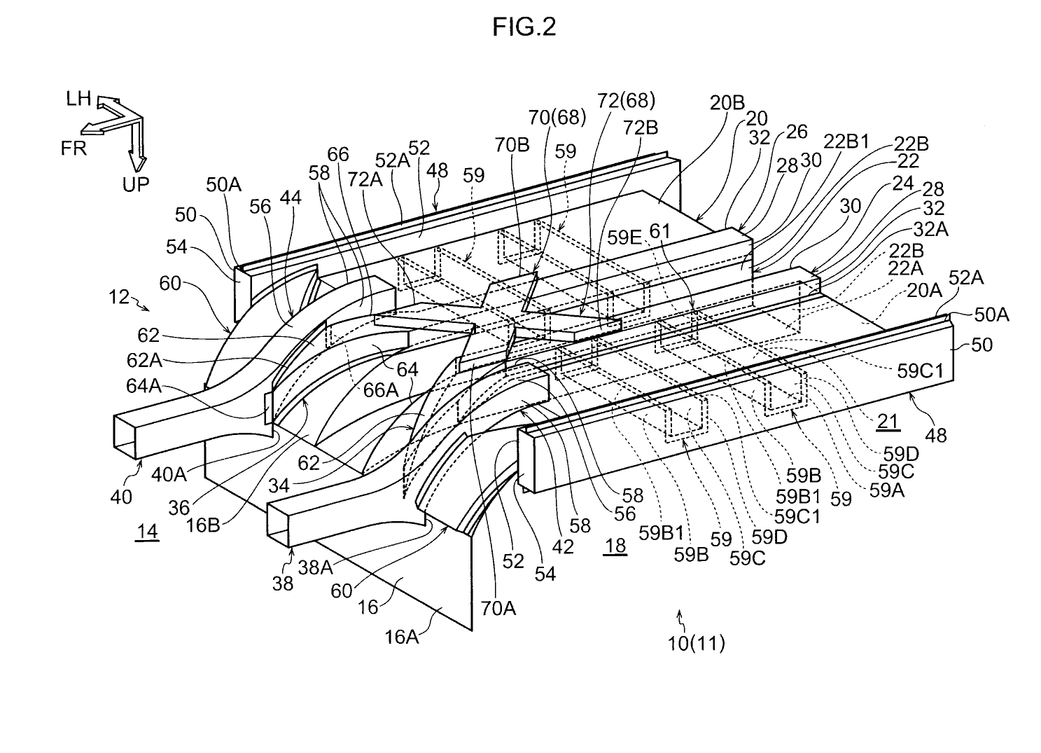

Explanation first follows regarding a configuration of a vehicle lower section structure according to the present exemplary embodiment. FIG. 1 illustrates a bottom view of the vehicle lower section structure 10 according to the present exemplary embodiment, and FIG. 2 illustrates a perspective view of the vehicle lower section structure 10 according to the present exemplary embodiment, as viewed obliquely from the front side and lower side.

As illustrated in FIG. 2, an engine room 14 is provided in a vehicle front section 12. The engine room 14 is partitioned from a vehicle cabin 18 by a dash-panel 16 (described below). A floor panel 20 configuring a floor of the engine room 14 is formed from a thin plate component, such as sheet steel, and extends along the vehicle front-rear direction and the vehicle width direction.

A tunnel section 22 is provided at a vehicle width direction central portion of the floor panel 20. The tunnel section 22 projects upward from an upper face 20A of the floor panel 20, and extends along the vehicle front-rear direction. The tunnel section 22 is formed with an inverted, substantially U-shaped cross-section profile taken along the vehicle width direction, opening toward the lower side, and includes an upper wall portion 22A, and a pair of side wall sections 22B positioned at the left and right of the upper wall portion 22A. The tunnel section 22 is integrally formed to the floor panel 20. However, for example, the floor panel 20 and the tunnel section 22 may be formed as separate members, and then integrated together by joining the two members by welding or the like.

The dash-panel 16 is provided at a front portion of the floor panel 20. The dash-panel 16 may be formed as a single component, or may be configured from two components, these being an upper section 16A including an upright wall configuring an upper portion of the dash-panel 16, and a lower section 16B joined to the floor panel 20 and configuring a lower portion of the dash-panel 16. The lower section 16B may also be integrally formed to the floor panel 20.

Lower tunnel reinforcements 24, 26 extending along the vehicle front-rear direction project downward from a lower face 20B of the floor panel 20 at the lower side of the floor panel 20 and at the vehicle width direction outer side of the tunnel section 22. The lower tunnel reinforcements 24, 26 are each formed with a substantially U-shaped cross-section profile taken along the vehicle width direction, open toward the upper side, and include a bottom wall section 28, and side wall portions 30, 32 positioned at the left and right of the bottom wall section 28.

The side wall portions 30 are positioned on the lower tunnel reinforcements 24, 26 at the inside of the tunnel section 22, and face toward inner faces 22B1 at the side wall sections 22B of the tunnel section 22, and are joined to the respective side wall sections 22B of the tunnel section 22, by welding or the like.

Outer flanges 32A extend from the upper end portions of the side wall portions 32 of the lower tunnel reinforcements 24, 26, and are bent toward the outer side so as to face a lower face 20B of the floor panel 20. The outer flanges 32A are joined to the lower face 20B of the floor panel 20, by welding or the like.

The lower tunnel reinforcements 24, 26 thereby form, with the floor panel 20, closed cross-section portions (not illustrated in the drawings). The cross-sectional rigidity as frame members is secured by the formation of such closed cross-section portions. Substantially the same applies to closed cross-section portions formed in other members.

As illustrated in FIG. 1, coupling portions 34, 36 are formed so as to extend respectively from front end portions 24A, 26A of the lower tunnel reinforcements 24, 26 toward the vehicle width direction outer side on progression toward the vehicle front side. Leading end portions of the coupling portions 34, 36 are formed so as to follow the shape of side wall portions 58 of side members 42, 44 that extend from rear end portions 38A, 40A of front side members 38, 40, described later. The leading end portions of the coupling portions 34, 36 are respectively joined by welding or the like to the side wall portions 58 of the side members 42, 44. The lower tunnel reinforcement 24 and the side member 42 are coupled together by the coupling portion 34, and the lower tunnel reinforcement 26 and the side member 44 are coupled together by the coupling portion 36.

As illustrated in FIG. 2, a rocker 48 extends along the vehicle front-rear direction at each vehicle width direction side of the floor panel 20. Each of the rockers 48 is configured including an outer rocker panel 50 disposed at the vehicle width direction outer side, and an inner rocker panel 52 disposed at the vehicle width direction inside. The outer rocker panel 50 and the inner rocker panel 52 are formed with substantially hat shaped cross-section profiles open at the side facing each other. A closed cross-section portion 54 extending in the vehicle front-rear direction is formed by joining together upper and lower pairs of flanges 50A, 52A by welding.

At the front side of the dash-panel 16, the front side member 38 is disposed along the vehicle width direction, between the lower tunnel reinforcement 24 and the rocker 48, and the front side member 40 is disposed along the vehicle width direction between the lower tunnel reinforcement 26 and the rocker 48.

The front side members 38, 40 extend along the vehicle front-rear direction, and upper portions of rear end portions of the rear end portions 38A, 40A of the front side members 38, 40 are respectively joined to the dash-panel 16 by welding or the like. The side members 42, 44 are provided curving from lower portions of the rear end portions 38A, 40A of the front side members 38, 40 toward the lower side on progression toward the rear side, following the shape of the lower portion side shape of the dash-panel 16, so as to form a downward facing convex shape.

The side members 42, 44 extend substantially horizontally toward the rear side at the lower side of the floor panel 20. Hereafter, on either side of the dash-panel 16, the front side of the side members 42, 44 will be referred to as the front side members 38, 40, and the rear side will be referred to as the side members 42, 44.

The side members 42, 44 are formed with substantially U-shaped cross-section profile taken along the vehicle width direction, opening toward the upper side. The side members 42, 44 are each configured including a lower wall portion 56, and the pair of side wall portions 58. Outer flanges (not illustrated in the drawings) extend respectively from upper end portions of the side wall portions 58 of the side members 42, 44, and bend toward the vehicle width direction outer side. The outer flanges are joined to the lower face 20B of the floor panel 20 by welding or the like. The side members 42, 44 accordingly form, with the floor panel 20, closed cross-section portions (not illustrated in the drawings).

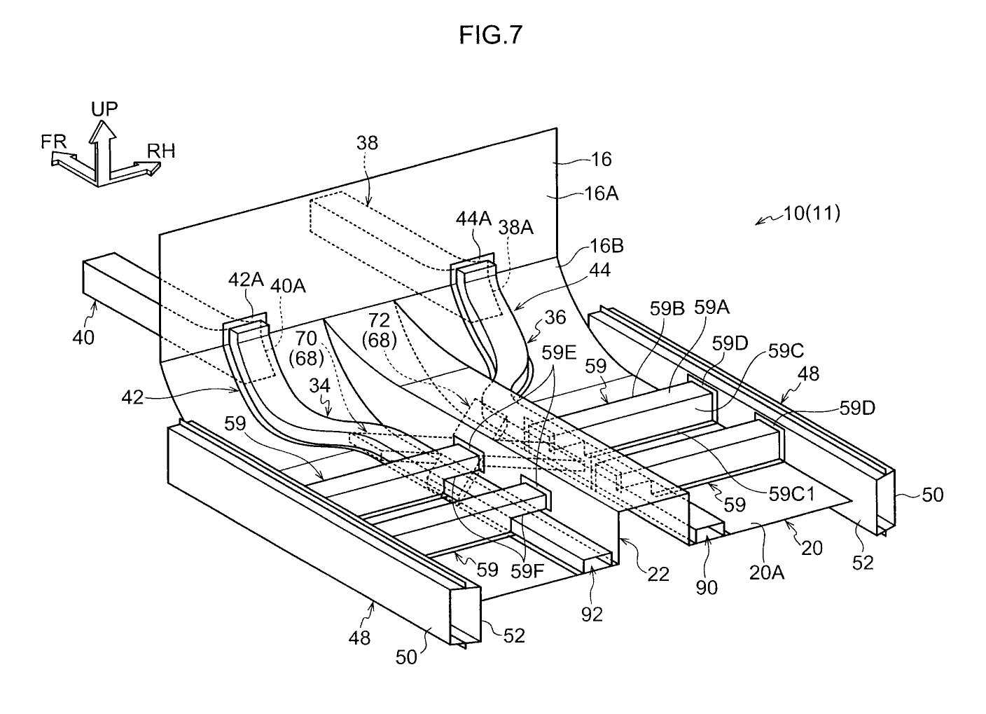

Floor cross members 59 (see FIG. 7) are provided to the upper face 20A of the floor panel 20 at the rear side of the dash-panel 16, running along the vehicle width direction between the rockers 48 and the tunnel section 22. Plural floor cross members 59 (in this case two) are disposed along the vehicle front-rear direction, at the left and right of the floor panel 20 with the tunnel section 22 therebetween. The floor cross members 59 disposed at the front side do not overlap with the side members 42, 44 in plan view, however the floor cross members 59 may be disposed so as to overlap with the side members 42, 44 in plan view.

The floor cross members 59 at the front side and the rear side are each formed in an inverted, substantially U-shaped cross-section profile taken along the vehicle front-rear direction, opening toward the lower side, and each include an upper wall portion 59A, and a front wall portion 59B and a rear wall portion 59C positioned at the front and rear of the upper wall portion 59A. A front flange 59B1 extends from a lower end portion of the front wall portion 59B and bends toward the front, and a rear flange 59C1 extends from a lower end portion of the rear wall portion 59C and bends toward the rear. The front flange 59B1 and the rear flange 59C1 are joined by welding or the like to the upper face 20A of the floor panel 20. The floor cross members 59 accordingly form, with the floor panel 20, closed cross-section portions 21.

At the rocker 48 side of each of the front side and rear side floor cross members 59, an outer flange 59D extends from outer side end portions of the upper wall portion 59A, the front wall portion 59B, and the rear wall portion 59C, and bends toward the outer side of the floor cross member 59 along a direction substantially orthogonal to the length direction of the floor cross member 59. The outer flanges 59D are formed with an inverted, substantially U-shape, as viewed along the length direction of the floor cross member 59, opening toward the lower side, and are joined to the inner rocker panel 52 by welding or the like.

At the tunnel section 22 side of each of the floor cross members 59, an outer flange 59E extends from outer side end portions of the upper wall portion 59A, the front wall portion 59B, and the rear wall portion 59C, and bends toward the outer side of the floor cross member 59 along a direction substantially orthogonal to the length direction of the floor cross member 59. The outer flanges 59E are formed with inverted, substantially U-shapes as viewed along the length direction of the floor cross member 59, opening toward the lower side, and are joined to the side wall portions 32 of the tunnel section 22 by welding or the like (second joint portions 61). The floor cross members 59 accordingly couple the rockers 48 and the tunnel section 22 together in the vehicle width direction.

As illustrated in FIG. 1, outer torque boxes 60 extend along the vehicle width direction between front portions (dash-panel 16 side) of the side members 42, 44, and the front portion of the respective rocker 48. The outer torque boxes 60 are formed with substantially U-shape cross-section profiles taken along the vehicle front-rear direction, opening toward the upper side, and form, with the lower face 20B of the floor panel 20, closed cross-section portions (not illustrated in the drawings).

One end portion of each of the outer torque boxes 60 is joined to the inner rocker panel 52 by welding or the like, and the other end portion of each of the outer torque boxes 60 is joined to the side wall portions 58 of the side members 42, 44 and to the dash-panel 16 by welding or the like. The outer torque boxes 60 are formed obliquely, so as to be disposed toward the vehicle width direction outer side on progression toward the rear side.

The side member 42, 44 and the dash-panel 16 side of each of the outer torque boxes 60 is set so as to have a larger cross-sectional area of closed cross-section portion, not illustrated in the drawings, than the rocker 48 side thereof This thereby makes collision load input to the dash-panel 16 and the outer torque boxes 60 transmittable to the side of the side members 42, 44 and the rocker 48.

As stated above, leading end portions 34A, 36A of the coupling portions 34, 36 are respectively joined to the side wall portions 58 of the side members 42, 44 by welding or the like. The coupling portions 34, 36 are integrally formed to the lower tunnel reinforcements 24, 26. Accordingly, the bottom wall sections 28 and side wall portions 30, 32 of the lower tunnel reinforcements 24, 26 are formed coupled to the bottom wall portion and side wall portions of the coupling portions 34, 36. However, for convenience of explanation, reference is made to bottom wall portions 62 and side wall portions 64, 66 on the coupling portions 34, 36 in order to distinguish these from the bottom wall sections 28 and the side wall portions 30, 32 of the lower tunnel reinforcements 24, 26.

As illustrated in FIG. 2, the front end portions of the bottom wall portions 62 of the coupling portions 34, 36 are respectively joined to the side wall portions 58 of the side members 42, 44 by welding or the like. Namely, a bottom flange 62A extends respectively from front end portions of the bottom wall portions 62 of the coupling portions 34, 36 and is bent downward. A front flange 64A extends respectively from front end portions of the side wall portions 64 of the coupling portions 34, 36 and is bent toward the front. A rear flange 66A extends respectively from front end portions of the side wall portions 66 and is bent toward the rear. The bottom flange 62A, the front flange 64A, and the rear flange 66A are respectively joined to the side wall portions 58 of the side members 42, 44 by welding or the like.

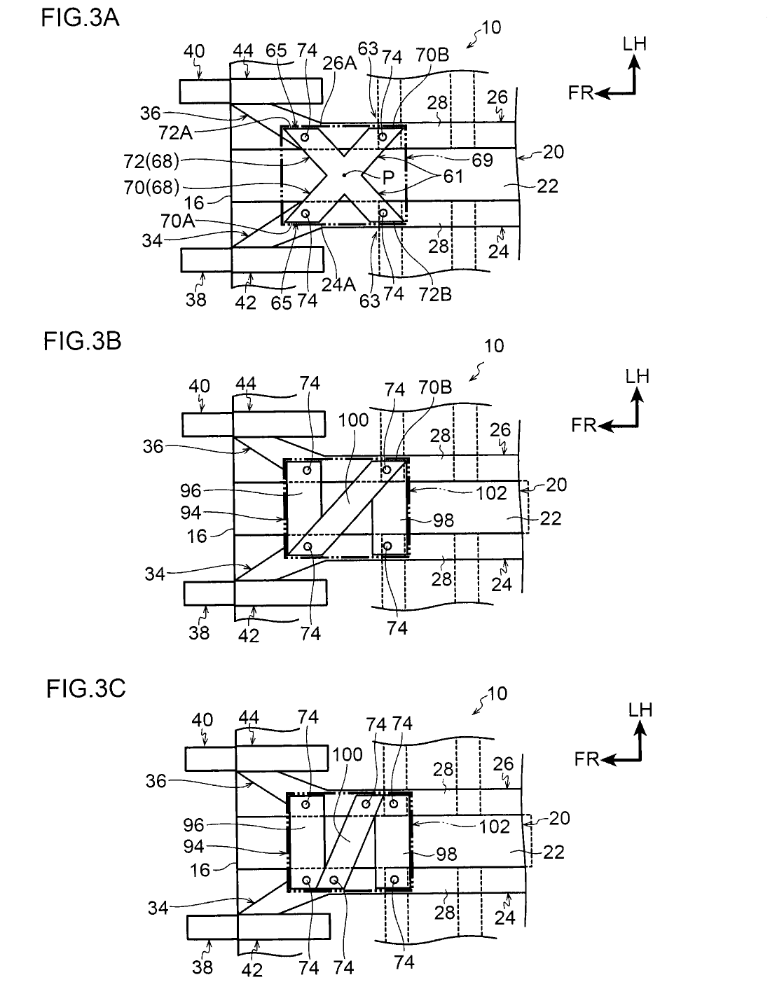

As illustrated in FIG. 3A, a front end portion 70A of a long plate shaped reinforcement member 70 is joined to the bottom wall portion 62 of the coupling portion 34 of the one lower tunnel reinforcement 24 side by a bolt 74 or by welding or the like (third joint portion 65). Namely, in plan view the front end portion 70A of the reinforcement member 70 substantially overlaps with the bottom wall portion 62 of the coupling portion 34. A rear end portion 70B of the reinforcement member 70 is joined to the bottom wall section 28 of the other lower tunnel reinforcement 26 by a bolt 74 or by welding or the like (first joint portion 63).

A front end portion 72A of a long plate shaped reinforcement member 72 is joined to the bottom wall portion 62 of the coupling portion 36 of the other lower tunnel reinforcement 26 side by a bolt 74 or by welding or the like (third joint portion 65). Namely, in plan view the front end portion 72A of the reinforcement member 72 substantially overlaps with the bottom wall portion 62 of the coupling portion 36. A rear end portion 72B of the reinforcement member 72 is joined to the bottom wall section 28 of the one lower tunnel reinforcement 24 by a bolt 74 or by welding or the like (first joint portion 63).

The reinforcement member 70 and the reinforcement member 72 intersect with each other, and an intersection point P of the reinforcement member 70 and the reinforcement member 72 is disposed so as to be at a substantially central portion of the tunnel section 22 in the vehicle width direction. Namely, in the present exemplary embodiment, an X-shaped member 68 formed in a substantially X-shape in plan view spans between the lower tunnel reinforcements 24, 26.

In the present exemplary embodiment, in plan view the first joint portion 63 of the reinforcement member 70 to the lower tunnel reinforcement 26 substantially overlaps with the second joint portion 61 between the floor cross member 59 and the lower tunnel reinforcement 26. The first joint portion 63 of the reinforcement member 72 to the lower tunnel reinforcement 24 substantially overlaps with the second joint portion 61 between the floor cross member 59 and the lower tunnel reinforcement 24 in plan view.

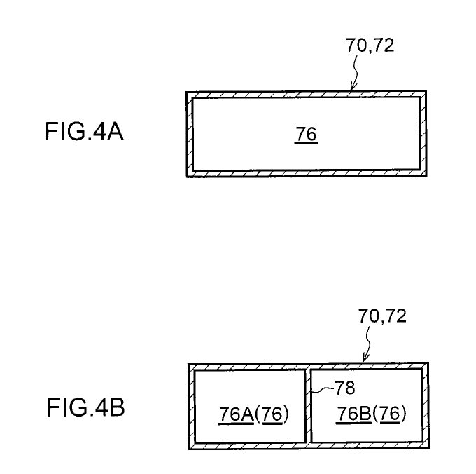

As illustrated in FIG. 4B, the reinforcement members 70, 72 are formed with a substantially rectangular cross-section profile taken along a width direction orthogonal to their length directions, and are respectively provided with a space 76. A partitioning wall 78, serving as a reinforcement portion to raise the cross-sectional rigidity, is provided inside the space 76, and, for example, the partitioning wall 78 substantially bisects the cross-sectional area of the space 76 in the width direction (76A, 76B).

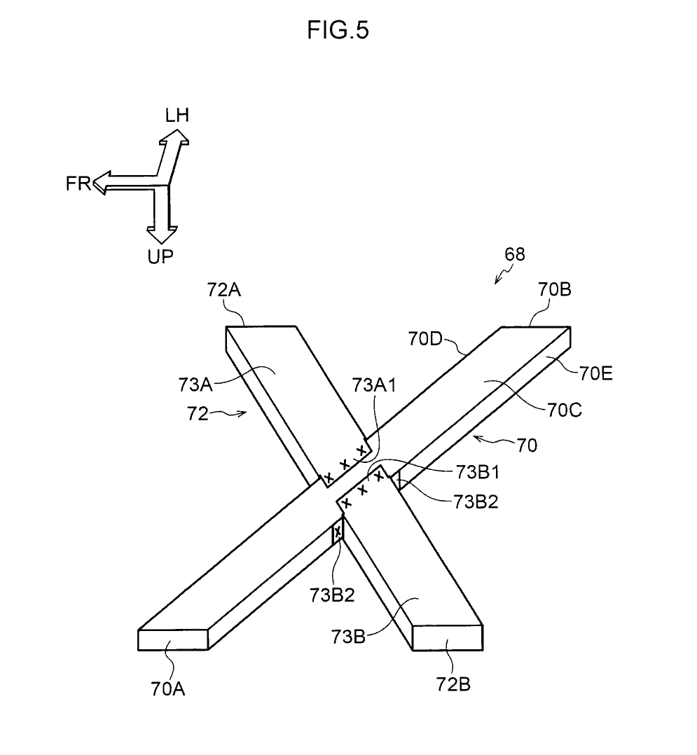

As illustrated in FIG. 5, at the X-shaped member 68, for example, the reinforcement member 72 is configured by a reinforcement member 73A and a reinforcement member 73B, divided at a substantially central portion in the length direction of the reinforcement member 72. A flange 73A1 juts out from a rear end portion of the reinforcement member 73A and faces a bottom wall portion 70C of the reinforcement member 70, and flange portions (not illustrated in the drawings) jut out respectively from the rear end portion of the reinforcement member 73A and face a side wall portion 70D of the reinforcement member 70.

A flange 73B1 juts out from a front end portion of the reinforcement member 73B and faces the bottom wall portion 70C of the reinforcement member 70, and flange portions 73B2 jut out from the front end portion of the reinforcement member 73B and face a side wall portion 70E of the reinforcement member 70. The reinforcement member 72 configured from the reinforcement member 73A and the reinforcement member 73B is integrally formed to the reinforcement member 70 by respectively welding the flange 73A1 etc. of the reinforcement member 73A and the flanges 73B1, 73B2 to the reinforcement member 70.

As illustrated in FIG. 1, in the present exemplary embodiment, the coupling portions 34, 36 respectively extend out from the front end portions 24A, 26A of the lower tunnel reinforcements 24, 26. The coupling portions 34, 36 are respectively coupled to the side members 42, 44. The front end portion 70A of the long plate shaped reinforcement member 70 is joined to the bottom wall portion 62 of the coupling portion 34 of the one lower tunnel reinforcement 24 side by the bolt 74 or by welding or the like (third joint portion 65). The rear end portion 70B of the reinforcement member 70 is joined to the other lower tunnel reinforcement 26 (first joint portion 63).

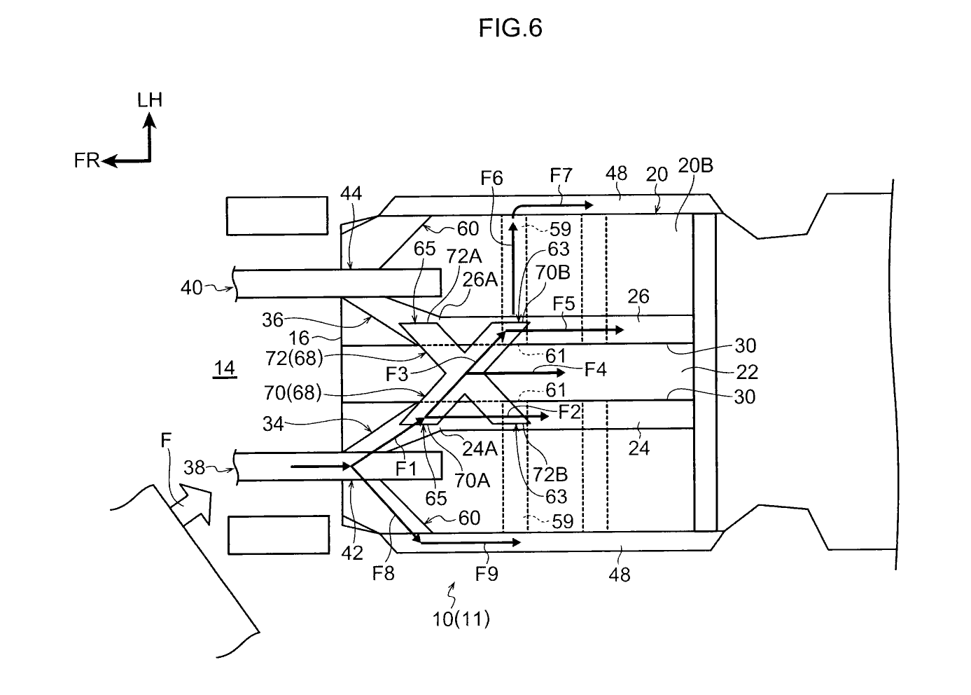

As illustrated in FIG. 6, in the event of an oblique collision from the vehicle width direction outer side of the front side member 38, a large collision load (F) is input from the front side member 38 and the side member 42 along the oblique direction of a vehicle 11. In the present exemplary embodiment, a collision load (F1) is transmitted to the coupling portion 34 joined to the side member 42 when the collision load (F) is input to the side member 42. Collision load is thereby transmitted through the coupling portion 34 to the front end portion 24A of the lower tunnel reinforcement 24.

The front end portion 70A of the long plate shaped reinforcement member 70 is joined to the bottom wall portion 62 of the coupling portion 34 of the one lower tunnel reinforcement 24 side by the bolt 74 or by welding or the like (third joint portion 65). The collision load (F1) transmitted to the coupling portion 34 is accordingly transmitted through the third joint portion 65 to the rear side of the lower tunnel reinforcement 24 (as load: F2) and also transmitted to the reinforcement member 70 (as load: F3). Namely, the collision load (F1) is distributed as the loads F2, F3.

Due to the reinforcement member 70 being joined so as to straddle between the lower tunnel reinforcement 24 and the lower tunnel reinforcement 26, a load F5 toward the rear side of the tunnel section 22 is transmitted through the lower tunnel reinforcements 24, 26.

When the collision load (F) is input to the side member 42, part of the collision load (F) is distributed to the outer torque box 60 (as load: F8), and part is transmitted through the outer torque box 60 to the rocker 48 (as load: F9).

The reinforcement member 70 is coupled to the one lower tunnel reinforcement 24 and further toward the rear side is coupled to the other lower tunnel reinforcement 26. Thus the collision load (F3) transmitted to the reinforcement member 70 is transmitted obliquely toward the rear side from the one lower tunnel reinforcement 24 to the other lower tunnel reinforcement 26 (as load: F3). Namely, the collision load F3 is transmitted past the tunnel section 22, to the lower tunnel reinforcement 26 disposed on the opposite side (the left side here) to the collision side (the right side here).

In the present exemplary embodiment, the first joint portion 63 of the reinforcement member 70 to the lower tunnel reinforcement 26 substantially overlaps with the second joint portion 61 between the floor cross member 59 and the lower tunnel reinforcement 26 in plan view. The collision load (F3) transmitted to the reinforcement member 70 is accordingly transmitted through the first joint portion 63 to the rear side of the other lower tunnel reinforcement 26 (F5), and is also transmitted through the second joint portion 61 to the floor cross member 59 (F6) and to the rocker 48 (F7). The collision load (F3) is distributed as the loads F4, F5, F6.

Thus the present exemplary embodiment enables the advantageous effect to be obtained of load transmission in an oblique direction toward the rear even in the event of an oblique collision. Although not illustrated in the drawings, similar applies, for example, when a large collision load is input to the vehicle 11 in an oblique direction from the front side member 40 and the side member 44. In the present exemplary embodiment “substantially overlaps” indicates, for example, that some amount of misalignment is permitted in plan view within a range enabling the transmission of collision load from the reinforcement members 70, 72 to the floor cross member 59.

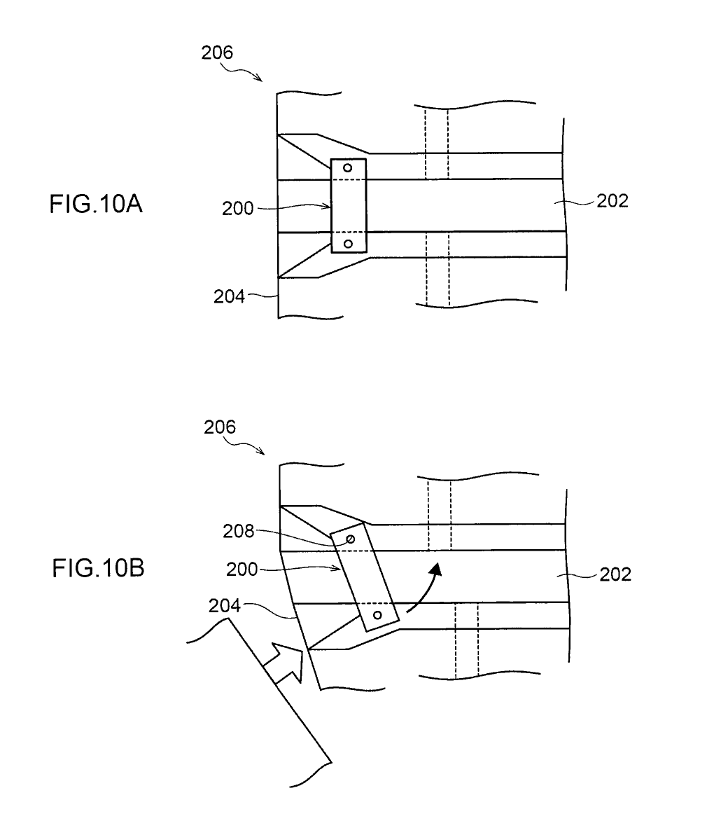

However, for example, in cases in which a reinforcement member 200 is disposed along the vehicle width direction of a tunnel section 202, as illustrated in FIG. 10A, when a large collision load (F) is input from a dash-panel 204 along an oblique direction to a vehicle 206 due to an oblique collision, as illustrated in FIG. 10B, the reinforcement member 200 rotates about a joint portion 208, and the tunnel section 202 is deformed.

In contrast thereto, in the present exemplary embodiment, as illustrated in FIG. 1, the reinforcement members 70, 72 are disposed so as to respectively straddle the tunnel section 22 in an oblique direction toward the rear side. This thereby enables deformation of the tunnel section 22 to be suppressed with respect to shear force acting on the tunnel section 22 along the vehicle width direction.

Moreover, in the present exemplary embodiment, due to the reinforcement members 70, 72 being provided respectively to the pair of lower tunnel reinforcements 24, 26 so as to intersect with each other as the X-shaped member 68, this thereby enables deformation of the tunnel section 22 to be further suppressed with respect to shear force acting on the tunnel section 22 along the vehicle width direction.

More specifically, due to the X-shaped member 68 being formed in a substantially X-shape in plan view, as illustrated in FIG. 3A, a virtual frame 69 is formed by the fastening points to the lower tunnel reinforcements 24, 26 (the bolts 74). This thereby enables rotation of the reinforcement members 70, 72 to be suppressed with respect to shear force acting on the tunnel section 22 along the vehicle width direction, enabling deformation of the tunnel section 22 to be further suppressed.

In the present exemplary embodiment, as illustrated in FIG. 4B, the space 76 is provided in each of the reinforcement members 70, 72, and the partitioning wall 78 is provided in the space 76. This thereby enables the cross-sectional rigidity and strength to be raised in the reinforcement members 70, 72, while achieving a reduction in weight. As illustrated in FIG. 4A, it is not always necessary to provide the partitioning wall 78 in the space 76 of the reinforcement members 70, 72.

Other Exemplary Embodiments

(1) In the present exemplary embodiment, as illustrated in FIG. 1, the coupling portions 34, 36 respectively extend from the front end portions 24A, 26A of the lower tunnel reinforcements 24, 26, and are integrally formed to the lower tunnel reinforcements 24, 26. However, in another configuration, other members serving as separate coupling members may be coupled to the front end portions 24A, 26A of the lower tunnel reinforcements 24, 26 and integrated to the lower tunnel reinforcements 24, 26.

(2) In the present exemplary embodiment, as illustrated in FIG. 2, an example in which the provided side of the lower tunnel reinforcements 24, 26 is the lower side of the floor panel 20, has been explained. However the configuration of the exemplary embodiment is not limited thereto. For example, as illustrated in FIG. 7, upper tunnel reinforcements 90, 92 may be provided at the upper side of the floor panel 20.

In such cases the rear end portions 38A, 40A of the front side members 38, 40 and front end portions 42A, 44A of the side members 42, 44 are respectively joined to the dash-panel 16 in a state facing each other with the dash-panel 16 therebetween. In FIG. 2, due to the side members 42, 44 extending from the rear end portions 38A, 40A of the front side members 38, 40, the coupling portions 34, 36 extending from the lower tunnel reinforcements 24, 26 are joined to the side members 42, 44.

However, in the exemplary embodiment illustrated in FIG. 7, the front side members 38, 40 and the side members 42, 44 are divided by the dash-panel 16. However, the upper tunnel reinforcement 92 and the coupling portion 34 are integrally formed, and the upper tunnel reinforcement 90 and the coupling portion 36 are integrally formed.

Accordingly, in this exemplary embodiment, the upper tunnel reinforcement 92 and the coupling portion 34 may be integrally formed to the side member 42, and the upper tunnel reinforcement 90 and the coupling portion 36 may be integrally formed to the side member 44. In such cases the front side members 38, 40 are equivalent to the side members of the first aspect 1. The coupling portions 34, 36 are indirectly coupled through the dash-panel 16 to the front side members 38, 40 serving as side members. Obviously the upper tunnel reinforcements, coupling portions, and side members may be formed as individual members.

The upper tunnel reinforcements 90, 92 in the present exemplary embodiment, similarly to the lower tunnel reinforcements 24, 26 described above (see FIG. 2), form closed cross-sections with the floor panel 20. Thus sometimes the floor panel 20 should be considered as being included in the upper tunnel reinforcements 90, 92. In such cases, for example, when the coupling portions 34, 36 overlap in plan view with the upper tunnel reinforcements 90, 92 and are joined to the floor panel 20 side, the floor panel 20 is a portion of the upper tunnel reinforcements 90, 92, and so sometimes the coupling portions 34, 36 should be considered as being joined to the upper tunnel reinforcements 90, 92.

Moreover, in the exemplary embodiment a cutaway portion 59F is provided at a lower portion side of each of the floor cross members 59 at one end side (the tunnel section 22 side) in the length direction of each of the floor cross member 59. The upper tunnel reinforcements 90, 92 are disposed so as to pass through the cutaway portions 59F.

In the exemplary embodiment, the X-shaped member 68 is joined to the lower face 20B of the floor panel 20 by welding or the like at positions overlapping respectively with the upper tunnel reinforcements 90, 92 in plan view. Specifically, a front portion of the reinforcement member 70 configuring a portion of the X-shaped member 68 is joined to the lower face 20B of the floor panel 20 at positions substantially overlapping with the upper tunnel reinforcement 92 in plan view. The front portion of the reinforcement member 70 may substantially overlap with the coupling portion 34 and the upper tunnel reinforcement 92 in plan view of the coupling portion 34. A rear portion of the reinforcement member 70 is joined to the lower face 20B of the floor panel 20 at the position overlapping with the upper tunnel reinforcement 90 in plan view.

A front portion of the reinforcement member 72 configuring another portion of the X-shaped member 68 is joined to the lower face 20B of the floor panel 20 at the position overlapping with the upper tunnel reinforcement 90 in plan view. The front portion of the reinforcement member 72 may substantially overlap with the upper tunnel reinforcement 90 and the coupling portion 36 in plan view of the coupling portion 36. A rear portion of the reinforcement member 72 is joined to the lower face 20B of the floor panel 20 at a position overlapping with the upper tunnel reinforcement 92 in plan view.

Although not illustrated in the drawings, the X-shaped member 68 may be directly fastened (joined) to the floor panel 20 by bolts or the like. In such cases, holes are formed in the floor panel 20. Therefore, although not illustrated in the drawings, for example, four bottomed-cylinder shaped brackets may be prepared to act as seats to fasten the bolts to, the brackets joined to the floor panel 20 by welding, and each of the respective bolts joined to the upper face of each of the brackets at a front portion or rear portion of the reinforcement members 70, 72 of the X-shaped member 68. This thereby negates the need to form holes in the floor panel 20, enabling a drop in rigidity of the floor panel 20 due to forming holes to be suppressed.

(3) In the present exemplary embodiment, as illustrated in FIG. 5, in the X-shaped member 68 the reinforcement member 72 configured from the reinforcement member 73A and the reinforcement member 73B is integrated to the reinforcement member 70 by welding. However the method for forming the X-shaped member 68 is not limited thereto.

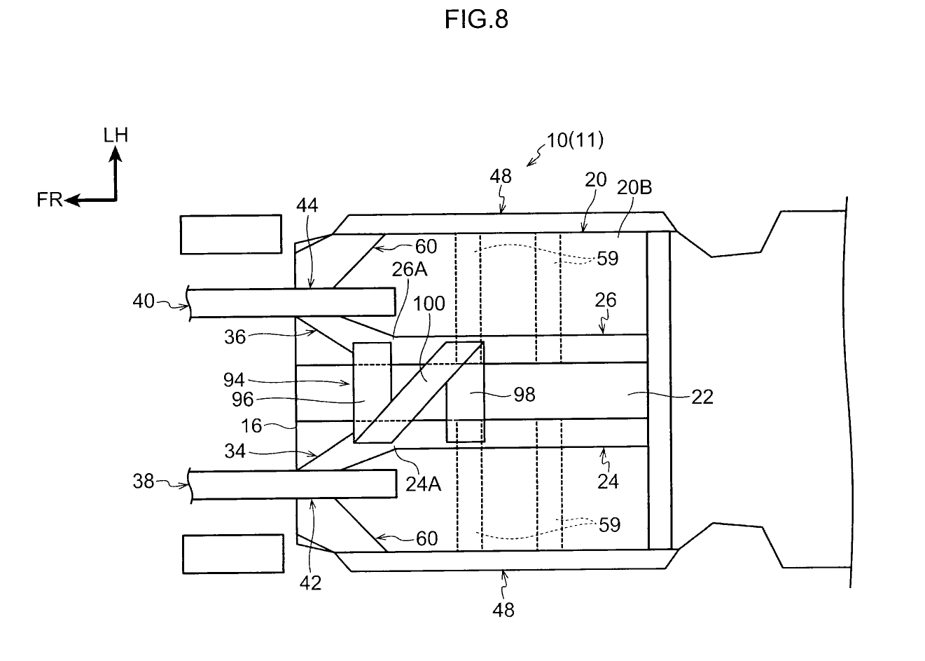

(4) In the present exemplary embodiment, as illustrated in FIG. 1, the X-shaped member 68 is formed in a substantially X-shape in plan view. However the configuration of the exemplary embodiment is not limited thereto. For example, as illustrated in FIG. 8, an N-shaped member 94 formed in an N-shape in plan view may be employed.

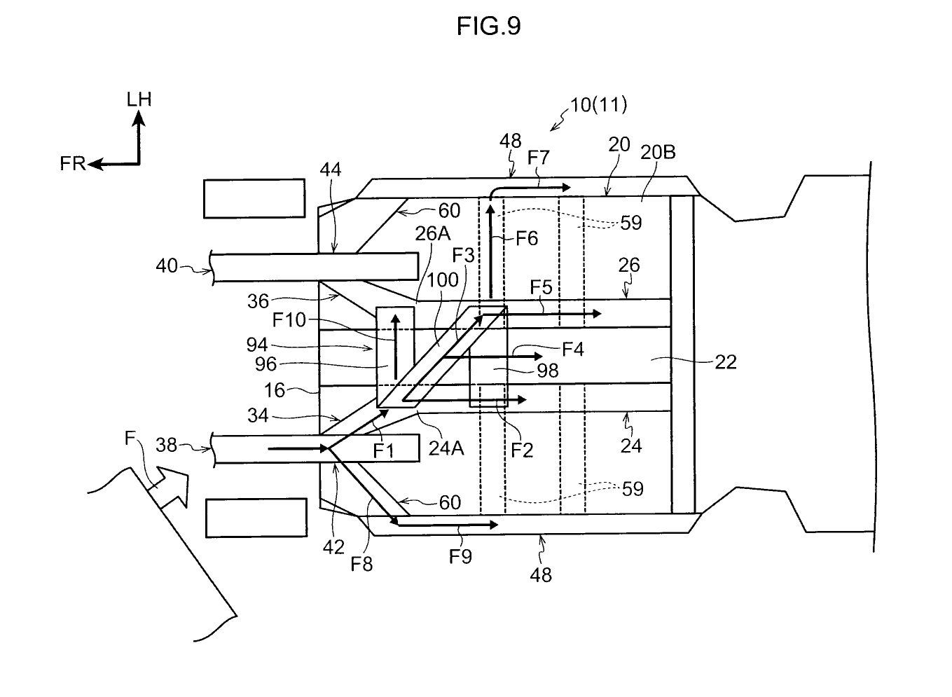

Specifically, as illustrated in FIG. 9, beam members 96, 98 are disposed between the lower tunnel reinforcement 24 and the lower tunnel reinforcement 26 so as to straddle the tunnel section 22 in the vehicle width direction. A front end portion of a reinforcement member 100 is fixed to the beam member 96 and to the lower tunnel reinforcement 24 side, and a rear end portion of the reinforcement member 100 is fixed to the beam member 98 and the lower tunnel reinforcement 26. Namely, the reinforcement member 100 is disposed obliquely to a line running along the vehicle front-rear direction, in a state straddling the tunnel section 22 between the beam member 96 and the beam member 98.

As illustrated in FIG. 6, in the event of an oblique collision from the vehicle width direction outer side of the front side member 38, when a large collision load (F) is input at the X-shaped member 68 from the front side member 38 and the side member 42 in an oblique direction to the vehicle 11, the collision load F1 transmitted from the side member 42 through the coupling portion 34 is distributed as loads F2, F3, and the load F3 is further distributed as loads F4, F5, F6.

As illustrated in FIG. 9, in cases in which the N-shaped member 94 is employed, part of the load Fl transmitted from the side member 42 through the coupling portion 34 is further transmitted to the coupling portion 36 side through the beam member 96.

Thus also in cases employing the N-shaped member 94, as illustrated in FIG. 3B, due to a virtual frame 102 being formed by the fastening points to the lower tunnel reinforcements 24, 26 (the bolts 74), rotation of the beam members 96, 98 is suppressed with respect to shear force acting along the vehicle width direction at the tunnel section 22, enabling deformation of the tunnel section 22 to be further suppressed.

(5) The method of forming the N-shaped member 94 is not limited thereto. For example, in FIG. 3B, the front end portion of the reinforcement member 100 is fixed to the beam member 96 and to the lower tunnel reinforcement 24, and the rear end portion of the reinforcement member 100 is fixed to the beam member 98 and to the lower tunnel reinforcement 26. In contrast thereto, in FIG. 3C, the front end portion of the reinforcement member 100 is fixed to the lower tunnel reinforcement 24, and the rear end portion of the reinforcement member 100 is fixed to the lower tunnel reinforcement 26. This thereby increases the number of fastening points (the bolts 74), and enables the N-shaped member 94 to be more strongly fixed to the lower tunnel reinforcements 24, 26. This thereby enables deformation of the tunnel section 22 to be further suppressed.

(6) In the present exemplary embodiment, the lower tunnel reinforcements 24, 26 and the tunnel section 22 are formed as separate members. However they may be integrally formed, and moreover the lower tunnel reinforcements 24, 26, the tunnel section 22, and the floor panel 20 may be integrally formed.

(7) In the present exemplary embodiment, an example has been explained in which the vehicle lower section structure 10 according to the present exemplary embodiment is applied to both vehicle width direction sides of the floor panel 20. However, the vehicle lower section structure 10 may be disposed on a single vehicle width direction side of the floor panel 20.

(8) In the present exemplary embodiment, the X-shaped member 68 is configured by the reinforcement member 70 and the reinforcement member 72. However, the X-shaped member 68 may be configured by the reinforcement member 70 or the reinforcement member 72.

Explanation has been given above of the present exemplary embodiments, however the present exemplary embodiments are not limited thereto, and obviously combinations of the exemplary embodiments and various modified examples may be employed, and various modes implemented within a range not departing from the spirit of the disclosure.

What is claimed is:

1. A vehicle lower section structure comprising:
a tunnel section that projects out toward an upper side in a vehicle up-down direction and extends along a vehicle front-rear direction at a central portion in a vehicle width direction of a floor of a vehicle cabin;
a pair of tunnel reinforcements that are each joined to a lower face side of the floor, that are each disposed at a vehicle width direction outer side of the tunnel section, and that each extend in the vehicle front-rear direction;
a side member that is disposed at an outer side of the respective tunnel reinforcement in the vehicle width direction and is provided along the vehicle front-rear direction;
a coupling portion that extends from a vehicle front-rear direction front end portion of the respective tunnel reinforcement, or is provided at a vehicle front-rear direction front end portion of the respective tunnel reinforcement, and that couples the tunnel reinforcement and the side member together; and
a reinforcement member of which a front portion side in the vehicle front-rear direction is joined to the coupling portion on the side of one of the tunnel reinforcements, and of which a rear portion side in the vehicle front-rear direction is joined to the other tunnel reinforcement.

2. The vehicle lower section structure of claim 1, wherein reinforcement members are respectively provided to each of the pair of tunnel reinforcements so as to intersect each other.

3. The vehicle lower section structure of claim 1, further comprising:
a pair of rockers respectively disposed at each vehicle width direction side of the floor and extending along the vehicle front-rear direction; and
a floor cross member that couples the respective rocker to the tunnel section in the vehicle width direction,
wherein a first joint portion where the rear portion side of the reinforcement member in the vehicle front-rear direction is joined to the tunnel reinforcement, and a second joint portion where the floor cross member is joined to the tunnel section, overlap with each other in plan view.

4. The vehicle lower section structure of claim 1, wherein the reinforcement member is configured by a member that has a hollow rectangular cross-section profile, and is provided with a reinforced portion with raised cross-sectional rigidity in a hollow portion.

5. A vehicle lower section structure comprising:
a tunnel section that projects out toward an upper side in a vehicle up-down direction and extends along a vehicle front-rear direction at a central portion in a vehicle width direction of a floor of a vehicle cabin;
a pair of tunnel reinforcements that are each joined to an upper face side of the floor, that are each disposed at a vehicle width direction outer side of the tunnel section, and that each extend in the vehicle front-rear direction;
a side member that is disposed at an outer side of the respective tunnel reinforcement in the vehicle width direction and is provided along the vehicle front-rear direction;
a coupling portion that extends from a vehicle front-rear direction front end portion of the respective tunnel reinforcement, or is provided at a vehicle front-rear direction front end portion of the respective tunnel reinforcement, and that couples the tunnel reinforcement and the side member together; and
a reinforcement member of which a front portion side in the vehicle front-rear direction is joined to the floor at a position overlapping in plan view with the coupling portion that is on the side of one of the tunnel reinforcements at a lower face side of the floor, and of which a rear portion side in the vehicle front-rear direction is joined to the floor at a position overlapping in plan view with the other tunnel reinforcement.

6. The vehicle lower section structure of claim 5, wherein reinforcement members are respectively provided to each of the pair of tunnel reinforcements so as to intersect each other.

7. The vehicle lower section structure of claim 5, further comprising:
a pair of rockers respectively disposed at each vehicle width direction side of the floor and extending along the vehicle front-rear direction; and
a floor cross member that couples the respective rocker to the tunnel section in the vehicle width direction,
wherein a first joint portion where the rear portion side of the reinforcement member in the vehicle front-rear direction is joined to the tunnel reinforcement, and a second joint portion where the floor cross member is joined to the tunnel section, overlap with each other in plan view.

8. The vehicle lower section structure of claim 5 wherein the reinforcement member is configured by a member that has a hollow rectangular cross-section profile, and is provided with a reinforced portion with raised cross-sectional rigidity in a hollow portion.
